(19) United States
(12) Patent Application Publication
(10) Pub. No.: US 2012/0236936 A1
(43) Pub. Date: Sep. 20, 2012

(54) Video coding based on edge determination

(76) Inventors: Christopher A. Segall, Camas, WA (US); Jie Zhao, Camas, WA (US)

(21) Appl. No.: 13/065,129

(22) Filed: Mar. 14, 2011

(51) Int. Cl. H04N 7/26

(52) U.S. Cl. 375/240.08; 375/E07.027

(57) ABSTRACT

A system encoding and decoding video using intra prediction that uses an edge based determination technique together with smoothing filters.

### CROSS-REFERENCE TO RELATED APPLICATIONS

None

### BACKGROUND OF THE INVENTION

The present invention relates to a system for parallel video coding techniques.

Existing video coding standards, such as H.264/AVC, generally provide relatively high coding efficiency at the expense of increased computational complexity. As the computational complexity increases, the encoding and/or decoding speeds tend to decrease. The use of parallel decoding and parallel encoding may improve the decoding and encoding speeds, respectively, particularly for multi-core processors. Also, parallel prediction patterns that depend solely on the number of prediction units within the block may be problematic for coding systems using other block structures because the number of prediction units may no longer correspond to the spatial size of the prediction unit.

### BRIEF DESCRIPTION OF THE SEVERAL VIEWS OF THE DRAWINGS

FIG. 1 illustrates encoding patterns.

FIG. 2 illustrates prediction modes.

FIGS. 3A-3I illustrates intra-prediction modes.

FIG. 4 illustrates a 16 block macroblock with two partition groups.

FIGS. 5A-5D illustrate macroblocks with two partition groups.

FIGS. 6A-6B illustrate macroblocks with three partition groups.

FIG. 7 illustrates a macroblock with multiple partition groups.

FIG. 8 illustrates a coding unit split.

FIG. 9A illustrates spatial subdivision of a slice using various units and indices.

FIG. 9B illustrates spatial subdivisions of a largest coding unit suitable for intra-prediction

FIG. 10 illustrates size based parallel decoding.

FIG. 11 illustrates one prediction unit with an intra_split_flag.

FIG. 12 illustrates type based parallel decoding.

FIG. 13 illustrates tree based parallel decoding.

FIG. 14A illustrates spatial windows based parallel decoding.

FIG. 14B illustrates the relationship between a window and a largest prediction unit.

FIG. 15 illustrates intra prediction mode direction in HEVC draft standard.

FIG. 16 illustrates arbitrary directional intra prediction modes defined by (dx, dy).

FIG. 17 illustrates table of smoothing filter indices depending on block size and intra prediction modes.

FIG. 18 illustrates edge based filters.

FIG. 19 illustrates alternative edge based filters.

FIG. 20 illustrates a table selection mechanism.

### DETAILED DESCRIPTION OF PREFERRED EMBODIMENT

Intra-prediction based video encoding/decoding exploits spatial relationships within a frame, an image, or otherwise a block/group of pixels. At an encoder, a block of pixels may be predicted from neighboring previously encoded blocks of pixels, generally referred to as reconstructed blocks, typically located above and/or to the left of the current block, together with a prediction mode and a prediction residual for the block. A block may be any group of pixels that preferably shares the same prediction mode, the prediction parameters, the residual data and/or any other signaled data. At a decoder, a current block may be predicted, according to the prediction mode, from neighboring reconstructed blocks typically located above and/or to the left of the current block, together with the decoded prediction residual for the block. In many cases, the intra prediction uses, for example, 4×4, 8×8, 16×16, and 32×32 blocks of pixels.

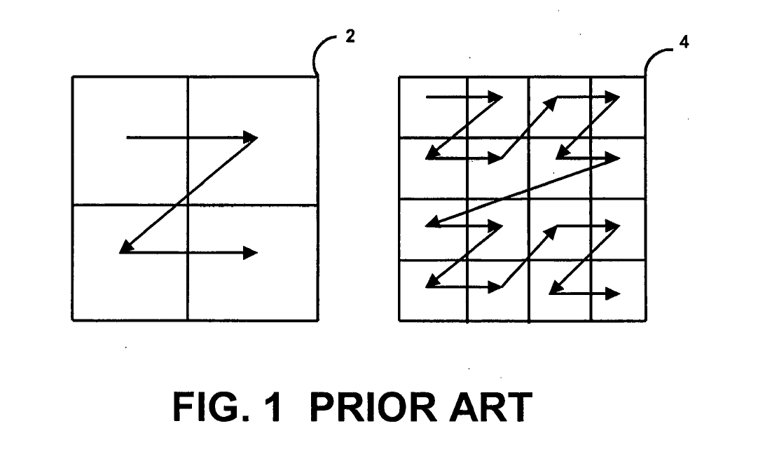

Referring to FIG. 1, with respect to the H.264/AVC video encoding standard, a 16×16 macroblock may include four 8×8 blocks or sixteen 4×4 blocks. The processing order for a group of four 8×8 blocks 2 of a 16×16 macroblock and for a group of sixteen 4×4 blocks 4 of a 16×16 macroblock may have a zig-zag processing order, or any other suitable order. Typically, the current block within the macroblock being reconstructed is predicted using previously reconstructed neighboring blocks and/or macroblocks. Accordingly, the processing of one or more previous blocks of a 16×16 macroblock is completed before other blocks may be reconstructed using its neighbors within the macroblock. The intra 4×4 prediction has more serial dependency in comparison to intra 8×8 and 16×16 prediction. This serial dependency may increase the number of operating cycles within a processor therefore slowing down the time to complete the intra prediction, and may result in an uneven throughput of different intra prediction types.

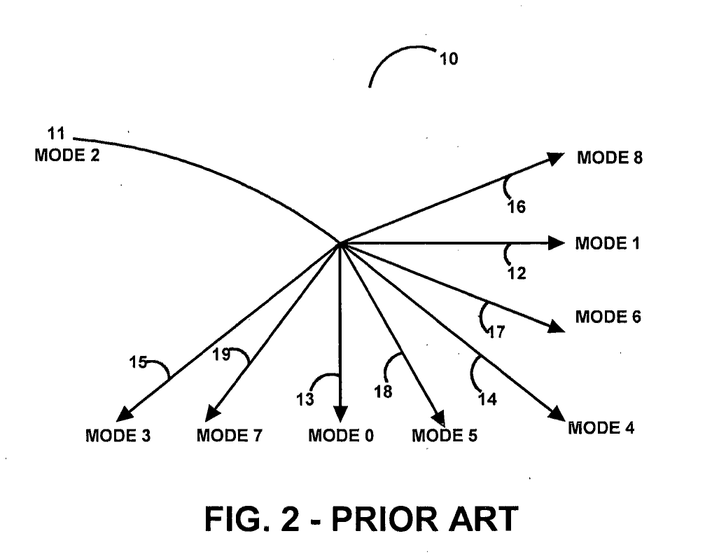

Referring to FIG. 2, in H.264/AVC, the intra 4×4 prediction and 8×8 prediction have nine prediction modes 10. Pixel values in the current block may be predicted from pixels values in a reconstructed upper and/or left neighboring block(s) relative to the current block. The direction of the arrow depicting a mode indicates the prediction direction for the mode. The center point 11 does not represent a direction so this point may be associated with a DC prediction mode, or otherwise referred to as “mode 2”. A horizontal arrow 12 extending to the right from the center point 11 may represent a horizontal prediction mode, also referred to as “mode 1”. A vertical arrow 13 extending down from the center point 11 may represent a vertical prediction mode, also referred to as “mode 0”. An arrow 14 extending from the center point 11 diagonally downward to the right at approximately a 45 degree angel from horizontal may represent a diagonal down-right (DDR) prediction mode, also referred to as “mode 4”. An arrow 15 extended from the center point 11 diagonally downward to the left at approximately a 45 degree angle from horizontal may represent a diagonal down-left (DDL) prediction mode, also referred to as “mode 3”. Both the DDR and DDL prediction modes may be referred to as diagonal prediction modes. An arrow 16 extending from the center point 11 diagonally upward to the right at approximately a 22.5 degree angle from horizontal may represent a horizontal up (HU) prediction mode, also referred to as “mode 8”. An arrow 17 extending from the center point 11 diagonally downward to the right at approximately a 22.5 degree angle from horizontal may represent a horizontal down (HD) prediction mode, also referred to as “mode 6”. An arrow 18 extending from the center point 11 diagonally downward to the right at approximately a 67.5 degree angle from horizontal may represent a vertical down right (VR) prediction mode, also referred to as “mode 5”. An arrow 19 extending from the center point 11 diagonally downward to the left at approximately a 67.5 degree angle from horizontal may represent a vertical down left (VL) prediction mode, also referred to as “mode 7”. The HU, HD, VR, and VL prediction modes may be referred to collectively as intermediate angle prediction modes.

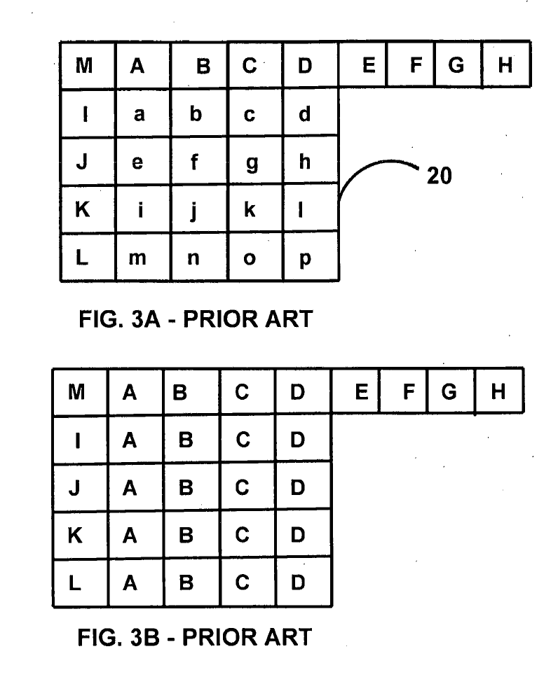

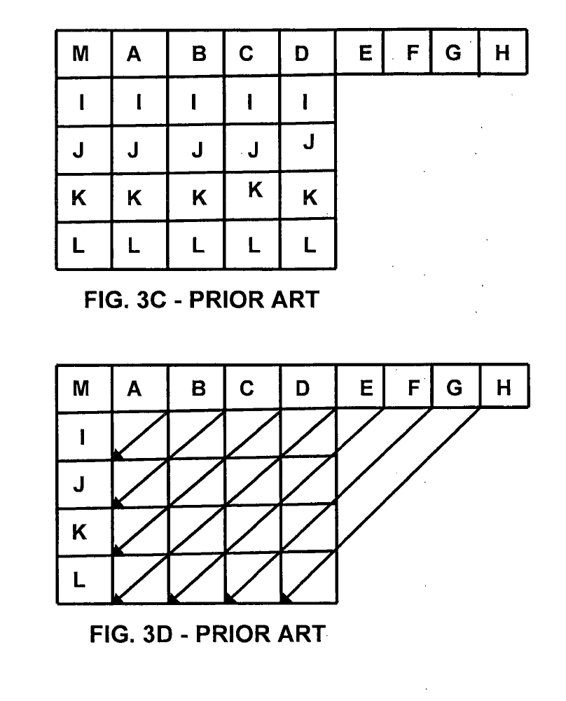

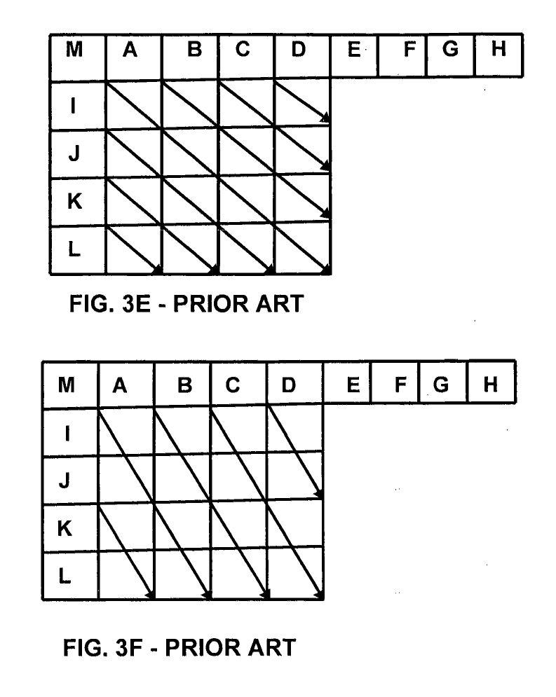

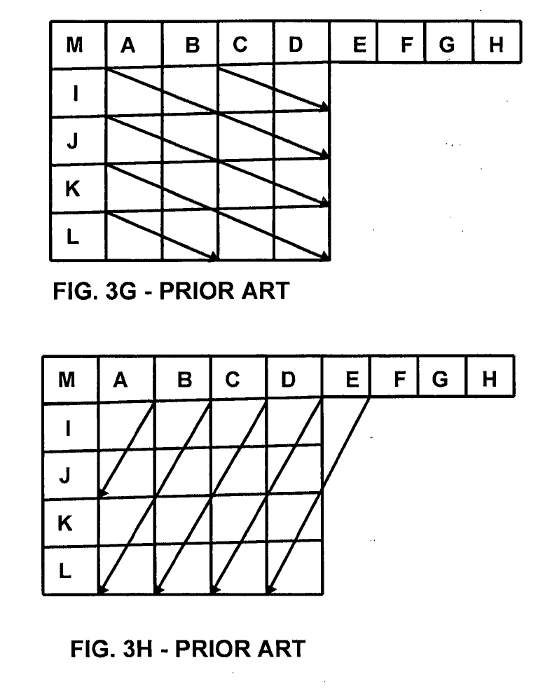

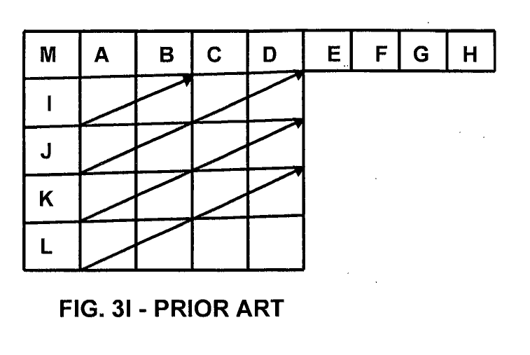

FIG. 3A illustrates an exemplary 4×4 block 20 of samples, labeled a-p that may be predicted from reconstructed, neighboring samples, labeled A-M. When samples are not available, such as for example when E-H are not available, they may be replaced by other suitable values.

Intra-prediction mode 0 (prediction mode direction indicated as 13 in FIG. 2) may be referred to as vertical mode intra prediction. In mode 0, or vertical mode intra prediction, the samples of a current block may be predicted in the vertical direction from the reconstructed samples in the block above the current block. In FIG. 3B, the samples labeled a-p in FIG. 3A are shown replaced with the label of the sample label from FIG. 3A from which they are predicted.

Intra-prediction mode 1 (prediction mode direction indicated as 12 in FIG. 2) may be referred to as horizontal mode intra prediction. In mode 1, or horizontal mode intra prediction, the samples of a block may be predicted in the horizontal direction from the reconstructed samples in the block to the left of the current block. FIG. 3C illustrates an exemplary horizontal prediction of the samples in a 4×4 block. In FIG. 3C, the samples labeled a-p in FIG. 3A are shown replaced with the label of the sample label from FIG. 3A from which they are predicted.

Intra-prediction mode 3 (prediction mode direction indicated as 15 in FIG. 2) may be referred to as diagonal down left mode intra prediction. In mode 3, the samples of a block may be predicted from neighboring blocks in the direction shown in FIG. 3D.

Intra-prediction mode 4 (prediction mode direction indicated as 14 in FIG. 2) may be referred to as diagonal down right mode intra prediction. In mode 4, the samples of a block may be predicted from neighboring blocks in the direction shown in FIG. 3E.

Intra-prediction mode 5 (prediction mode direction indicated as 18 in FIG. 2) may be referred to as vertical right mode intra prediction. In mode 5, the samples of a block may be predicted from neighboring blocks in the direction shown in FIG. 3F.

Intra-prediction mode 6 (prediction mode direction indicated as 17 in FIG. 2) may be referred to as horizontal down mode intra prediction. In mode 6, the samples of a block may be predicted from neighboring blocks in the direction shown in FIG. 3G.

Intra-prediction mode 7 (prediction mode direction indicated as 19 in FIG. 2) may be referred to as vertical left mode intra prediction. In mode 7, the samples of a block may be predicted from neighboring blocks in the direction shown in FIG. 3H.

Intra-prediction mode 8 (prediction mode direction indicated as 16 in FIG. 2) may be referred to as horizontal up mode intra prediction. In mode 8, the samples of a block may be predicted from neighboring blocks in the direction shown in FIG. 3I.

In intra-prediction mode 2, which may be referred to as DC mode, all samples labeled a-p in FIG. 3A may be replaced with the average of the samples labeled A-D and I-L in FIG. 3A.

The system may likewise support four 16×16 intra prediction modes in which the 16×16 samples of the macroblock are extrapolated from the upper and/or left hand encoded and reconstructed samples adjacent to the macroblock. The samples may be extrapolated vertically, mode 0 (similar to mode 0 for the 4×4 size block), or the samples may be extrapolated horizontally, mode 1 (similar to mode 1 for the 4×4 size block). The samples may be replaced by the mean, mode 2 (similar to the DC mode for the 4×4 size block), or a mode 3, referred to as plane mode, may be used in which a linear plane function is fitted to the upper and left hand samples.

In order to decrease the processing delays, especially when using parallel processors, it is desirable to process selected blocks of pixels of a larger group of pixels, such as a macroblock, in a parallel fashion. A first group of blocks of pixels may be selected from a macroblock (or other larger set of pixels) and a second group of blocks of pixels may be selected from the remaining pixels of the macroblock. Additional or alternative groups of blocks of pixels may be selected, as desired. A block of pixels may be any size, such as an m×n size block of pixels, where m and n may be any suitable number. Preferably, each of the blocks within the first plurality of blocks are encoded using reconstructed pixel values from only one or more previously encoded neighboring macroblocks, and each of the blocks within the second plurality of blocks may be encoded using the reconstructed pixel values from previously encoded macroblocks and/or blocks associated with the first plurality of blocks. In this manner, the blocks within the first plurality of blocks may be decoded using reconstructed pixel values from only neighboring macroblocks, and then the blocks within the second plurality of blocks may be decoded using the reconstructed pixel values from reconstructed blocks associated with the first plurality of blocks and/or neighboring macroblocks. The encoding and decoding of one or more blocks may be, fully or partially, done in a parallel fashion.

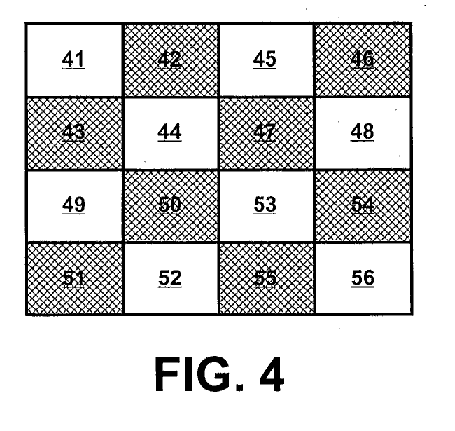

For example, a macroblock with N blocks, the degree of parallelism may be N/2. The increased speed of 4×4 intra prediction for a 16×16 macroblock may be generally around a factor of 8, which is significant. Referring to FIG. 4, a macroblock has a size of M×N, where M and N may be any suitable number. The sixteen blocks 41-56 may be grouped into two (or more) sets of eight blocks (or otherwise) each according to a checker board pattern (or other pattern). Eight blocks in a first set are shown as 41, 44, 45, 48, 49, 52, 53, and 56, and the eight blocks shown in the other set are 42, 43, 46, 47, 50, 51, 54, and 55. The first set of blocks may be decoded, or encoded, in parallel using previously reconstructed macroblocks, and then the second set of blocks may be decoded, or encoded, in parallel using the reconstructed blocks associated with the first set and/or previously reconstructed macroblocks. In some cases, the second set of blocks may start being decoded before the first set of blocks are completely decoded.

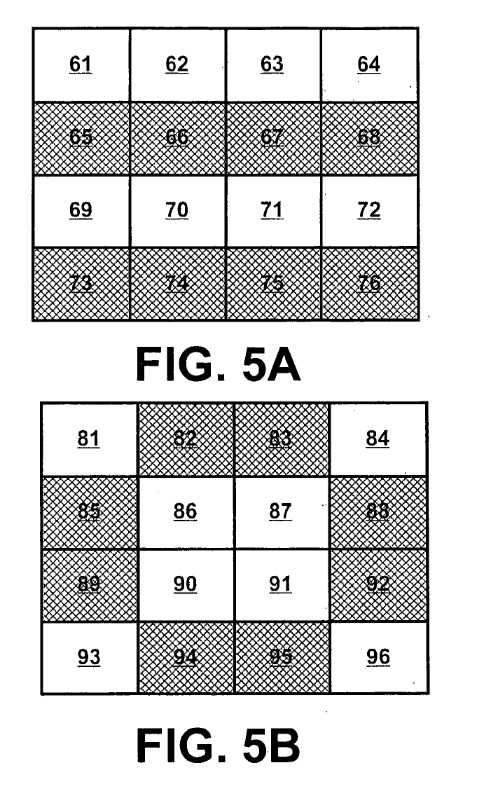

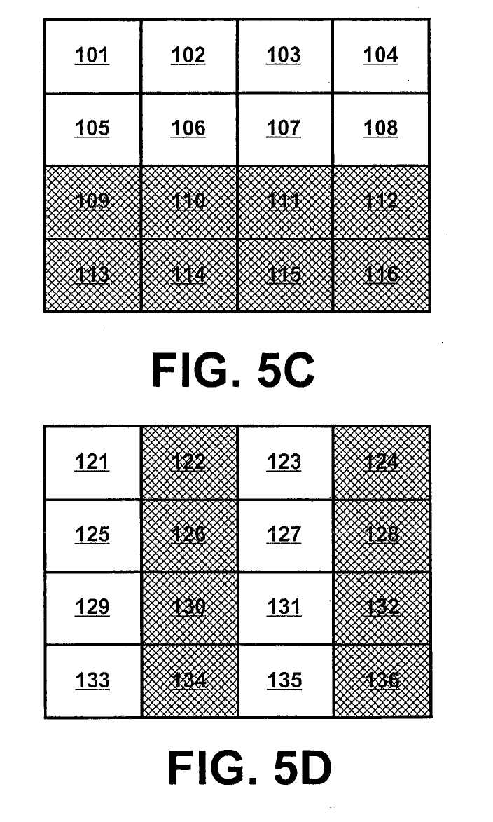

Alternative partition examples are shown in FIGS. 5A-5D. Referring to FIG. 5A, blocks 61-76 may be grouped in two groups. The first group may include 61-64 and 69-72, while the second group may include 65-68 and 73-76. Referring to FIG. 5B, blocks 81-96 may be grouped in two groups. The first group may include 81, 84, 86, 87, 90, 91, 93, and 96, while the second group may include 82, 83, 85, 88, 89, 92, 94, and 95. Referring to FIG. 5C, blocks 101-116 may be grouped in two groups. The first group may include 101-108, while the second group may include 109-116. Referring to FIG. 5D, blocks 121-136 may be grouped in two groups. The first group may include 121, 123, 125, 127, 129, 131, 133, and 135, while the second group may include 122, 124, 126, 128, 130, 132, 134, and 136.

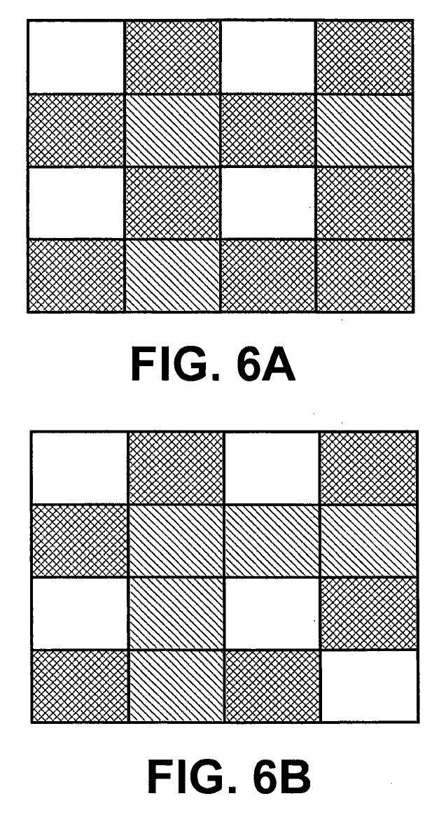

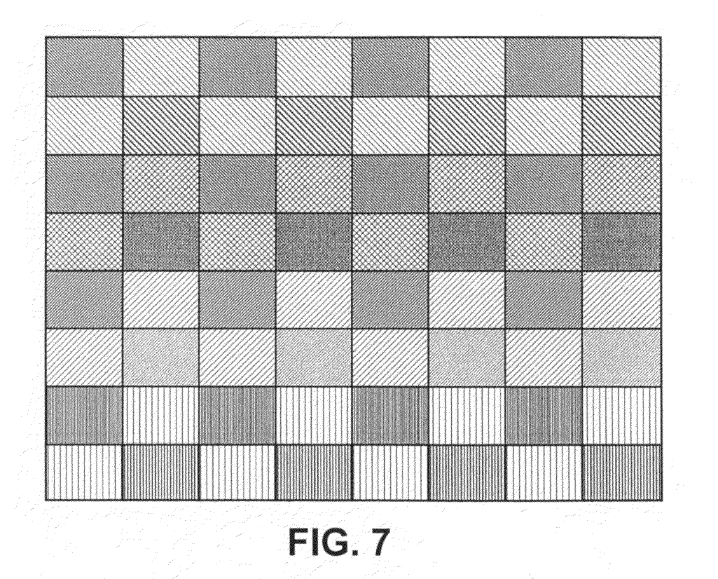

Alternatively, the macroblock may be partitioned into a greater number of partitions, such as three sets of blocks. Moreover, the partitions may have a different number of blocks. Further, the blocks may be the same or different sizes. In general, a first plurality of blocks may be predicted in the encoding process using reconstructed pixel values from only previously encoded neighboring macroblocks. A second plurality of blocks may be subsequently predicted in the encoding process using reconstructed pixel values from the previously encoded blocks associated with the first plurality of blocks and/or using reconstructed pixel values from previously encoded neighboring macroblocks. The third plurality of blocks may be subsequently predicted in the encoding process using reconstructed pixel values from the previously encoded blocks associated with the first plurality of blocks, and/or reconstructed pixel values from the previously encoded blocks associated with the second plurality of blocks, and/or reconstructed pixel values from previously encoded neighboring macroblocks. FIGS. 6A and 6B depict exemplary three-group partitions of a 16×16 macroblock. FIG. 7 shows an exemplary partition of 4×4 blocks in a 32×32 macroblock.

The bit stream may require signaling which encoding pattern is used for the decoding, or otherwise the default decoding may be predefined. In some embodiments, the neighboring upper and left macroblock pixel values may be weighted according to their distance to the block that is being predicted, or using any other suitable measure.

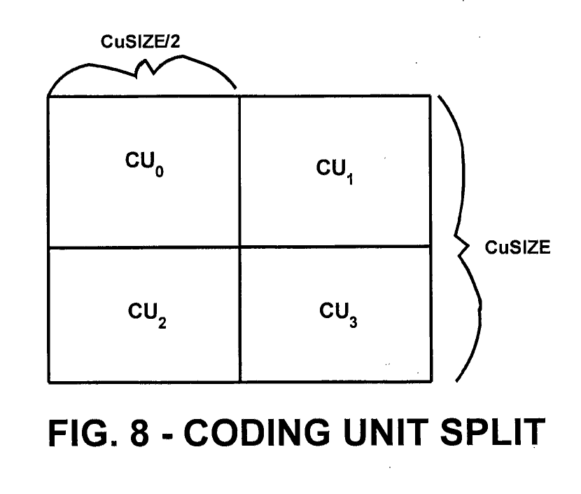

Since Jan. 2010, ITU.T and MPEG has started standardization effort on a HEVC (High Efficiency Video Coding) standard. In some cases, such as the HEVC working draft the video encoding does not use fixed block sizes, but rather includes two or more different block sizes within a macroblock. In some implementations, the partitioning of an image may use the concepts of coding unit (CU), prediction unit (PU), and prediction partitions. At the highest level, this technique divides a picture into one or more slices. A slice is a sequence of largest coding units (LCU) that correspond to a spatial window within the picture. The coding unit, may be for example, a group of pixels containing one or more prediction modes/partitions and it may have residual data. The prediction unit, may be for example, a group of pixels that are predicted using the same prediction type, such as intra prediction or intra frame prediction. The prediction partition, may be for example, a group of pixels predicted using the same prediction type and prediction parameters. The largest coding unit, may be for example, a maximum number of pixels for a coding unit. For example, a 64×64 group of pixels may correspond to a largest coding unit. These largest coding units are optionally sub-divided to adapt to the underlying image content (and achieve efficient compression). This division is determined by an encoder and signaled to the decoder, and it may result in a quad-tree segmentation of the largest coding unit. The resulting partitions are called coding units, and these coding units may also be subsequently split. Coding unit of size CuSize may be split into four smaller coding units, CU0, CU1, CU2 and CU3 of size CuSize/2 as shown in FIG. 8. This may be accomplished by signaling a split_coding_unit_flag to specify whether a coding unit is split into coding units with half horizontal and vertical size. The sub-division is recursive and results in a highly flexible partitioning approach.

Once no further splitting of the coding unit is signaled, the coding units are considered as prediction units. Each prediction unit may have multiple prediction partitions. For an intra coded prediction unit, this may be accomplished by signaling an intra_split_flag to specify whether a prediction unit is split into four prediction units with half horizontal and vertical size.

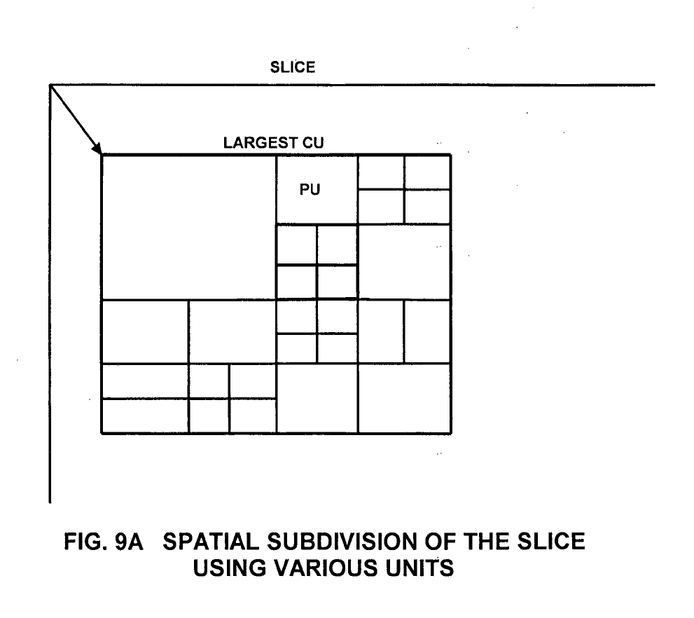

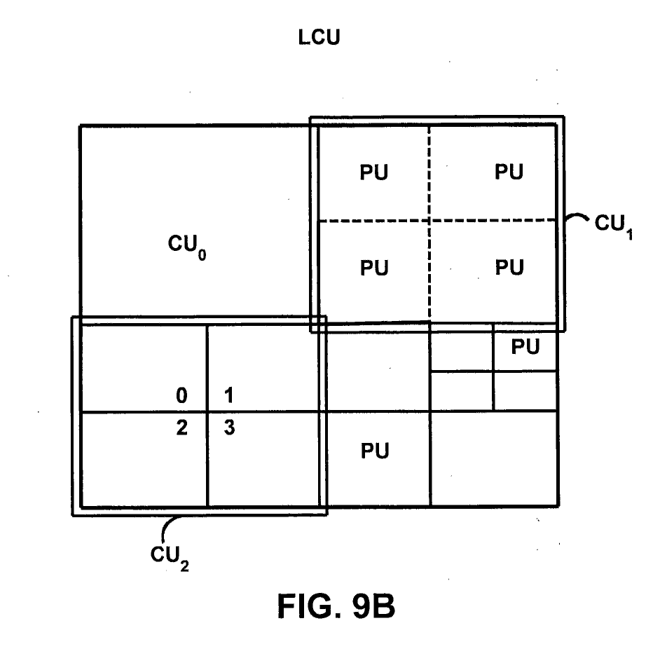

Additional partitioning mechanisms may be used for inter-coded blocks, as desired. FIG. 9A illustrates an example spatial subdivision of one slice with various units. FIG. 9B illustrates spatial subdivisions of a largest coding unit suitable for intra-prediction. In this case, the processing for multiple coding units are preferably done in parallel. In addition, the processing for multiple prediction units are preferably done in parallel, such as 0, 1, 2, 3, of CU2; and such as the 4 divisions of CU1.

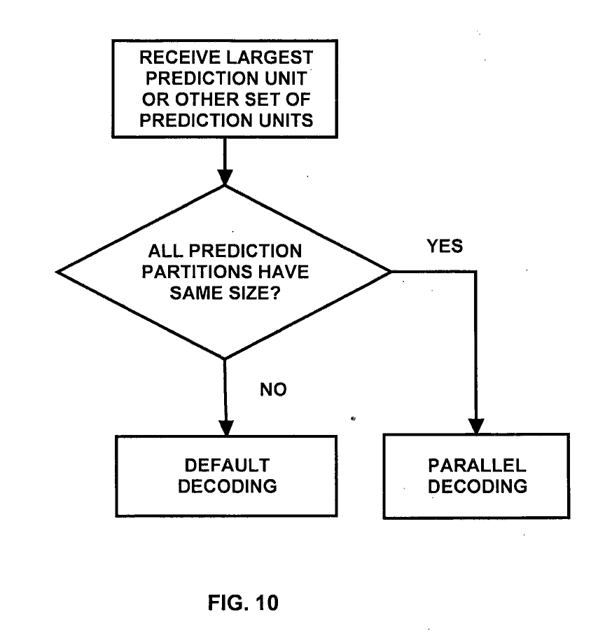

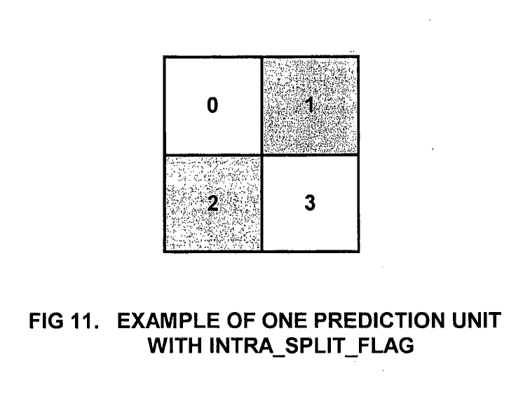

In some embodiments referring to FIG. 10, preferably the system uses parallel intra prediction only for prediction units of the largest prediction unit that all contain partitions having the same size. The largest prediction unit, may be for example, the largest group of pixels being defined by a single set of data. This may be determined by inspection of the largest prediction unit, or other set of prediction units. That may be signaled from within the bitstream by a flag, such as an intra_split_flag, for the prediction unit. When the intra_split_flag signals that the prediction unit is sub-divided into equally sized prediction partitions, then the parallel intra prediction system may be applied within that prediction unit. When the intra_split_flag does not signal that the prediction unit is sub-divided into equally sized prediction partitions, then the parallel intra prediction system is preferably not applied. An exemplary splitting of the prediction unit into four prediction partitions is illustrated in FIG. 11, which are then grouped into two sets for parallel processing. For example, partitions 1 and 2 may be grouped to one set and partitions 0 and 3 may be grouped to another set. The first set is then predicted using the prediction unit neighbors while the second set is predicted using prediction unit neighbors as well as the neighbors in the first set.

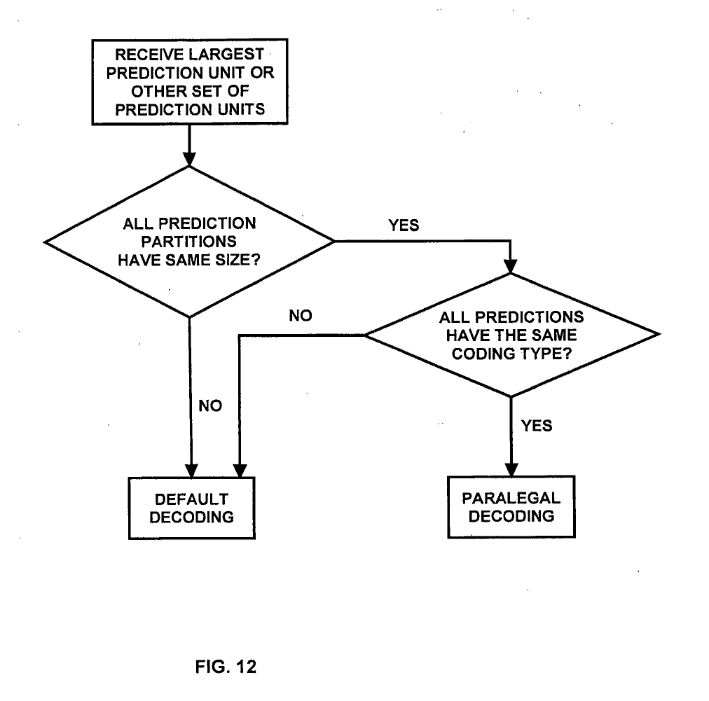

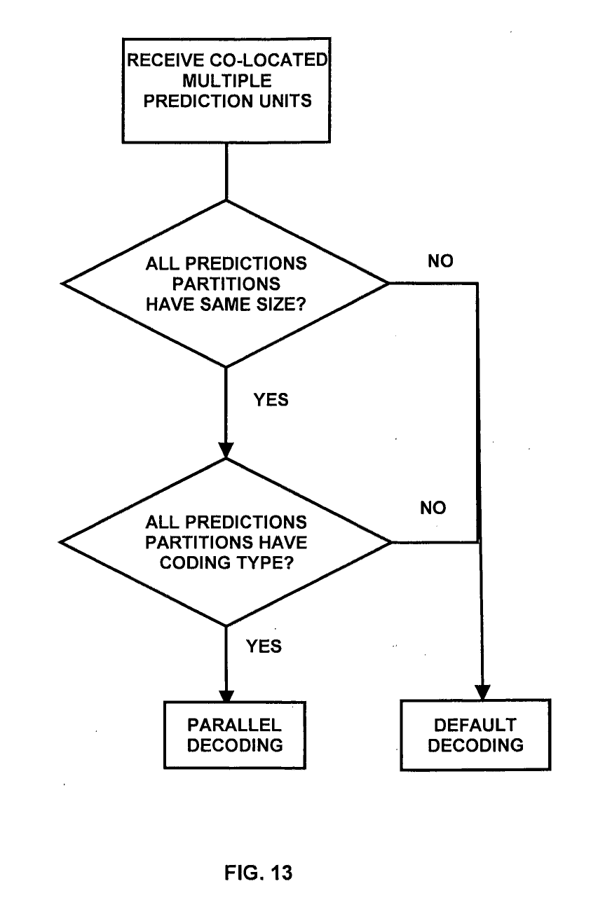

In some embodiments referring to FIG. 12, in addition to the partitions having the same size, the system may further use parallel intra prediction across multiple prediction units that have prediction partitions that are of the same size and/or coding type (e.g:, intra-coded vs. motion compensated). Referring to FIG. 13, these prediction units preferably be spatially co-located within a coding unit that was subsequently split to create the multiple prediction units. Alternatively, the multiple prediction units may be spatially co-located within a coding unit that was recursively split to create the prediction units. In other words, the prediction units have the same parent in the quad-tree.

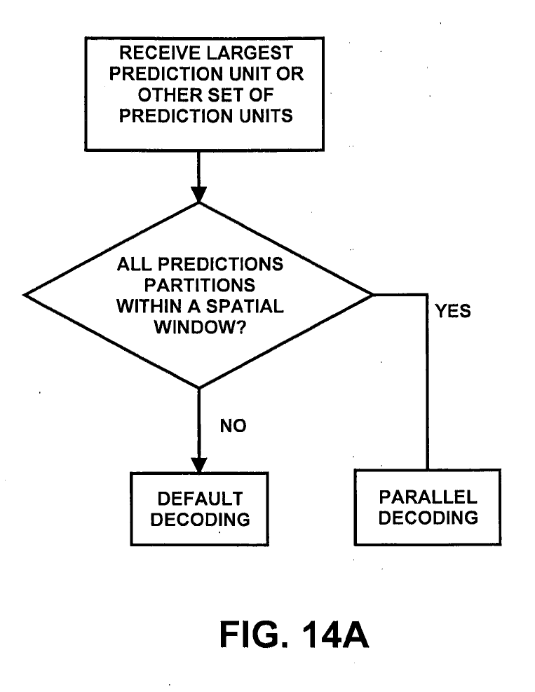

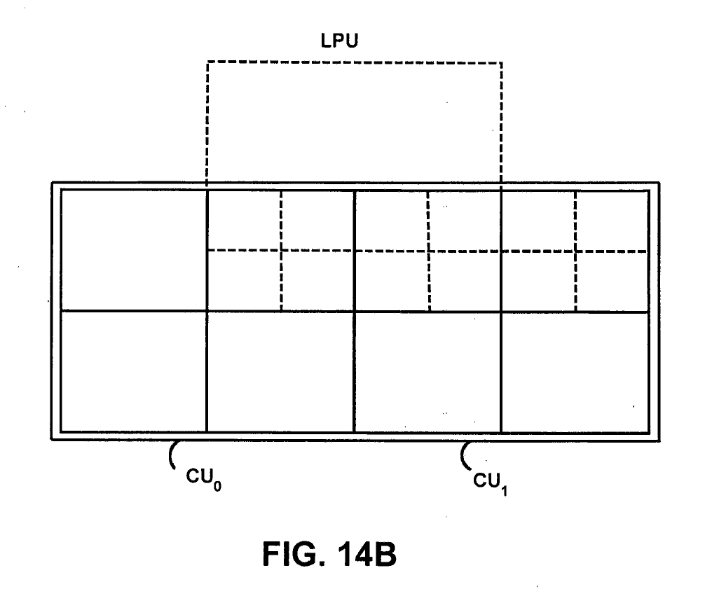

In an embodiment the system may use parallel intra prediction across multiple coding units. The multiple coding units preferably have the same spatial size and prediction type (e.g., intra coded). Referring to FIG. 14A, in another embodiment, the parallel intra prediction technique may be based on the size of the prediction area. For example, the system may restrict the use of the parallel intra prediction technique to pixels within an N×N spatial window. For example, the system may restrict use of the parallel intra prediction technique only to pixels within a 16×16 spatial window. Note that the data used for processing the pixels within the window may be located outside of the window.

As described above, the spatial window may be referred to as a parallel unit. Alternatively, it may be referred to as a parallel prediction unit or parallel coding unit. The size of the parallel unit may be signaled in the bit-stream from an encoder to a decoder. Furthermore, it may be defined in a profile, defined in a level, transmitted as meta-data, or communicated in any other manner. The encoder may determine the size of the parallel coding unit and restricts the use of the parallel intra prediction technology to spatial pixels that do not exceed the size of the parallel unit. The size of the parallel unit may be signaled to the decoder. Additionally, the size of the parallel unit by be determined by table look, specified in a profile, specified in a level, determined from image analysis, determined by rate-distortion optimization, or any other suitable technique.

For a prediction partition that is intra-coded, the following technique may be used to reconstruct the block pixel values. First, a prediction mode is signaled from the encoder to the decoder. This prediction mode identifies a process to predict pixels in the current block from previously reconstructed pixel values. As a specific example, a horizontal predictor may be signaled that predicts a current pixel value from a previously reconstructed pixel value that is near and to the left of the current pixel location. As an alternative example, a vertical predictor may be signaled that predicts a current pixel value from a previously reconstructed pixel value that is near and above the current pixel location. In general, pixel locations within a coding unit may have different predictions. The result is predicted pixel values for all the pixels of the coding unit.

Additionally, the encoder may send transform coefficient level values to the decoder. At the decoder, these transform coefficient level values are extracted from the bit-stream and converted to transform coefficients. The conversion may consist of a scaling operation, a table look-up operation, or any other suitable technique. Following the conversion, the transform coefficients are mapped into a two-dimensional transform coefficient matrix by a zig-zag scan operation, or other suitable mapping. The two-dimensional transform coefficient matrix is then mapped to reconstructed residual values by an inverse transform operation, or other suitable technique. The reconstructed residual values are added (or otherwise) to the predicted pixel values to form a reconstructed intra-predicted block.

The zig-zag scan operation and the inverse residual transform operation may depend on the prediction mode. For example, when a decoder receives a first prediction mode from an encoder for a first intra-predicted block, it uses the prediction process, zig-zag scan operation and inverse residual transform operation assigned to the first prediction mode. Similarly, when a decoder receives a second prediction mode from an encoder for a second intra-predicted block, it uses the prediction process, zig-zag scan operation and inverse residual transform operation assigned to the second prediction mode. In general, the scan pattern used for encoding and decoding may be modified, as desired. In addition, the encoding efficiency may be improved by having the scan pattern further dependent on which group of the parallel encoding the prediction units or prediction partitions are part of.

In one embodiment the system may operate as follows: when a decoder receives a first prediction mode from an encoder for a first intra-predicted block that is assigned to a first partition, the decoder uses the prediction process, zig-zag scan operation and inverse residual transform operation assigned to the first prediction mode and the first partition. Similarly, when a decoder receives a second prediction mode from an encoder for a second intra-predicted block that is assigned to a second partition, the decoder uses the prediction process, zig-zag scan operation and inverse residual transform operation assigned the second prediction mode and said second partition. For example, the first and second partitions may correspond to a first and a second group for parallel encoding. Note that for the case that the first prediction mode and the second prediction mode have the same value but the first partition and the second partition are not the same partition, then the first zig-zag scan operation and first inverse residual transform operation may not be the same as the second zig-zag scan operation and second inverse residual transform. This is true even if the first prediction process and second prediction process are the same. For example, the zig-zag scan operation for the first partition may use a horizontal transform and a vertical scan pattern, while the zig-zag scan operation for the second partition may use a vertical transform and a horizontal scan pattern.

There may be different intra prediction modes that are block size dependent. For block sizes of 8×8, 16×16, 32×32, there may be, for example, 34 intra prediction modes which provide substantially finer angle prediction compared to the 9 intra 4×4 prediction modes. While the 9 intra 4×4 prediction modes may be extended in some manner using some type of interpolation for finer angle prediction, this results in additional system complexity.

In the context of parallel encoding, including parallel encoding where the block sizes may have different sizes, the first set of blocks are generally predicted from adjacent macroblocks. Instead of extending the prediction modes of the 4×4 blocks to the larger blocks (e.g., 8×8, 16×16, 32×32, etc.), thereby increasing the complexity of the system, the system may reuse the existing prediction modes of the larger blocks. Therefore, the 4×4 block prediction modes may take advantage of the greater number of prediction modes identified for other sizes of blocks, such as those of 8×8, 16×16, and 32×32.

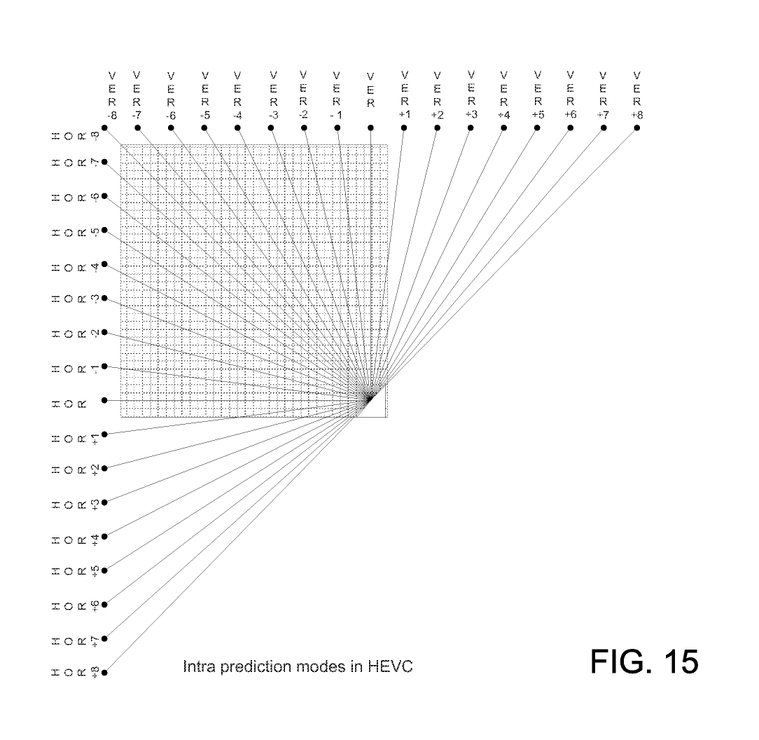

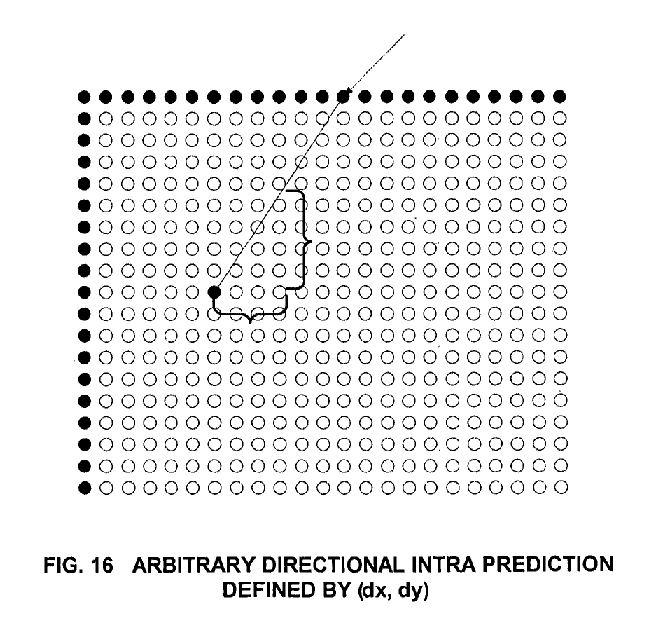

In many cases, the intra prediction modes of the 4×4 block size and prediction modes of the larger block sizes may be different. To accommodate the differences, it is desirable to map the 4×4 block prediction mode numbers to larger block prediction mode numbers. The mapping may be according to the prediction direction. For example, the intra prediction of a 4×4 block may have 17 directional modes; while intra prediction of the 8×8 block size, the 16×16 block size, and the 32×32 block size may have 34 direction modes; the intra prediction of a 64×64 block may have 3 directional modes. Different angular prediction modes and the ADI prediction are show in FIG. 15 and FIG. 16, respectively. Even though the prediction modes of various blocks size may be different, for directional intra prediction, one mode may be mapped to another if they have the same or a close direction. For example, the system may map the value for mode 4 of the 4×4 block prediction to mode 9 of the 8×8 block prediction for the case that mode 4 related to a horizontal mode prediction and mode 9 related to a horizontal mode prediction.

For a block the additional neighbors from the bottom and right may be used when available. Rather than extending the different prediction modes, the prediction from the bottom and the right neighbors may be done by rotating the block and then utilizing existing intra prediction modes. Predictions by two modes that are of 180 degree difference may be weighted interpolated as follows,

p(y, x)=w*p1(y, x)+(1−w) p2(y, x)

where p1 is the prediction that doesn't include the bottom and right neighbors, and p2 is the prediction that doesn't include the above and left neighbors, and w is a weighting factor. The weighting tables may be the weighted average process between the predictions from above and left neighbors, and neighbors from bottom and right neighbors as follows:

First, derive value yTmp at pixel (x,y) as weighted average of p1 and p2, where weight is according to the distance to the above and bottom neighbors

yTmp=(p1*(N−y)+p2*y)/N;

Second, derive value xTmp at pixel (x,y) as weighted average of p1 and p2, where weight is according to the distance to the left and right neighbors

xTmp=(p1*(N−x)+p2*x)/N;

Third, the final predicted value at pixel (y,x) is a weighted average of xTmp and yTmp. The weight depends on the prediction direction. For each direction, represent its angle as (dx, dy), as represented in ADI mode in FIG. 16. For mode without direction, it is preferable to set dx=1, dy=1.

p(y, x)=(abs(dx)* xTmp+abs(dy)*yTmp)/(abs(dx)+abs(dy));

where N is the block width pl is the prediction that doesn't include the bottom and right neighbors, and p2 is the prediction that doesn't include the above and left neighbors.

The intra prediction technique may be based, at least in part, upon applying filtering to the pixel values. For example, for a neighbor pixel p(i) to be used for intra prediction, the pixel may be filtered using a pair of filters. The pair of filters may be characterized by:

p1(i)=(p(i−1)+2*p(i)+p(i+1))>>2 Filter 1:

p2(i)=(p1(i−1)+2*p1(i)+p1(i+1))>>2 Filter 2:

As it may be observed, Filter 1 performs an averaging (e.g., smoothing) operation by summing the values of the previous pixel, the current pixel times 2, and the next pixel, the total sum of which is divided by four. As it may be observed, Filter 2 performs a further averaging (e.g., smoothing) operating by summing the values of the previous, the current pixel filtered by Filter 1 times 2, and the next pixel, the sum of which is divided by four. Thus for selecting neighboring values to be used for intra prediction the system has the original pixels to select from (mode 0); the pixels as a result of Filter 1 to select from (mode 1); and the pixels as a result of Filter 2 to select from (mode 2).

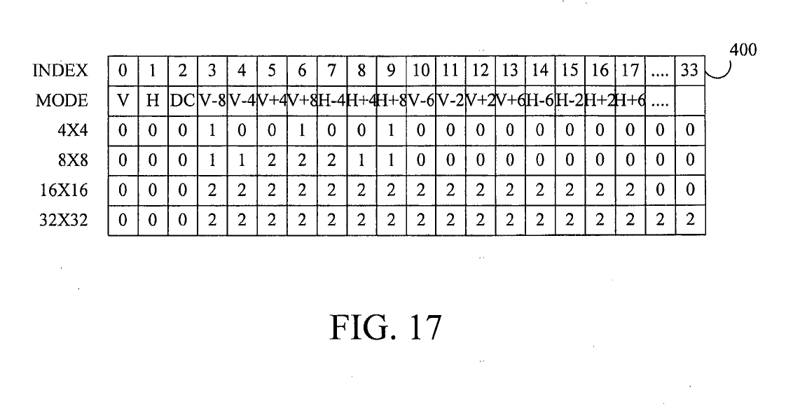

Referring to FIG. 17, the video bit stream may include mode index values 400, such as intra prediction mode index values from 0 to 33. Each of the mode index values 400 has a corresponding intra prediction technique where the selected data from the filters is based upon block size. For example, for mode index value 8, 4×4 block size uses filter index 0 (e.g., original pixels), 8×8 block size uses filter index 1 (e.g., pixels from Filter 1), 16×16 block size uses filter index 2 (e.g., pixels from Filter 2), and 32×32 block size uses filter index 2 (e.g., pixels from Filter 2). Accordingly, the intra prediction technique for a particular index value is block size dependent. This technique is also known as Mode dependent intra smoothing. While this technique provides effective coding efficiency for many video sequences, the technique tends to decrease the resulting image quality with selected video sequences.

The table of FIG. 17 does not always provide an optimal solution to the intra prediction for a frame. While attempting all combinations of index values for a particular frame of a video may improve the coding efficiency, it tends to result in a highly complex encoder. To increase the coding efficiency for an expanded breadth of video sequences, it is desirable to modify the filtering technique to accommodate additional characteristics of the image content. It was determined that if the neighbor pixels to an original pixel are on or otherwise adjacent to an edge of an object, then using the intra smoothing filters are likely to make the resulting encoded image worse.

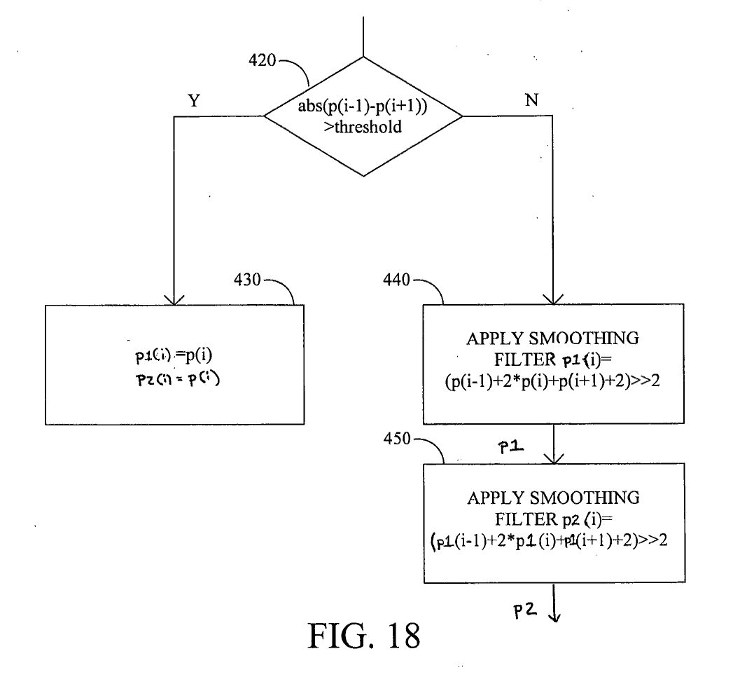

Referring to FIG. 18, for a pixel p(i) an edge based determination 420 is used. The edge based determination 420 may use a set of three pixels to determinate whether the absolute value of the difference between adjacent pixels is greater than a threshold. One characterization of the edge based determination 420 may be abs(p(i−1)−p(i+1))>threshold. If the edge based determination 420 indicates the existence of an edge greater than the threshold, then the filtered lines being generated p1(i) and p2(i) 430 is set to the input pixels, such as p(i). If the edge based determination 420 does not indicate the existence of an edge greater than the threshold, then the filtered lines being generated p1(i) and p2(i), are modified by a smoothing filter 440, such as p1(i)=(p(i−1)+2*p(i)+p(i+1)+2)>>2. The filter 440 performs an averaging (e.g., smoothing) operation by summing the values of the previous pixel, the current pixel times 2, and the next pixel, plus 2 to account for rounding, the total sum of which is divided by four. The filter 450 performs a further averaging (e.g., smoothing) operation by summing the values of the previous pixel, the previously filtered pixel times 2, and the next pixel, plus 2 to account for rounding, the total sum of which is divided by four. The result is filtered lines of values p1(i) and p2(i) having a combination of the original pixel values, smoothed pixel values, and further smoothed pixel values.

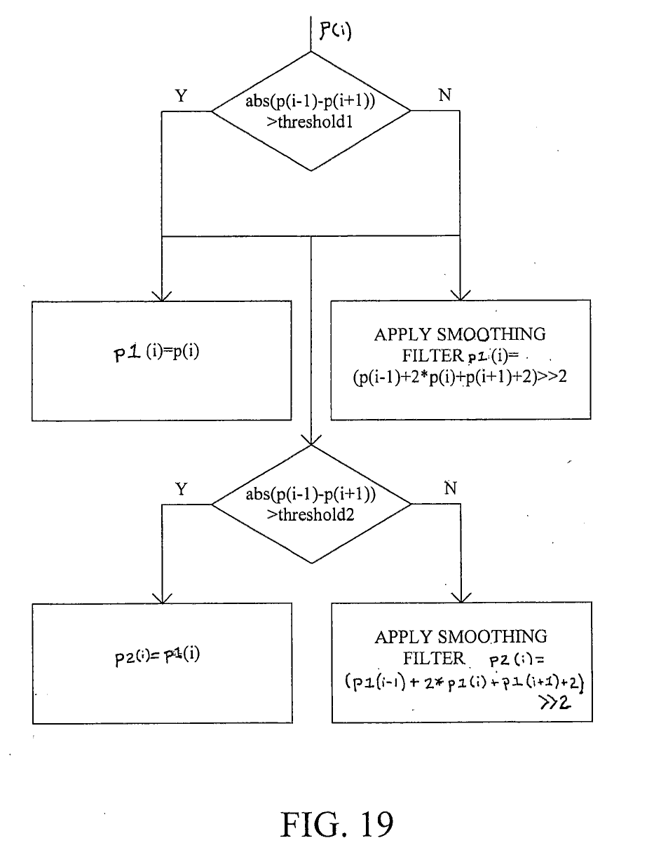

The threshold value may be pre-defined value, a value provided in the bit stream, a value periodically provided in the bit stream, and/or determined based upon image content of the frame. The threshold may be dependent on the block size. For example, large block sizes tend to benefit from more intra smoothing. The threshold may be dependent on the image resolution. For example, the three pixel edge determination tends to work well for small resolution sequences but for larger resolution sequences additional pixels for the edge determination tends to work well. The threshold may also be dependent on the quantization parameter. Referring to FIG. 19, there may be a first threshold value (e.g., threshold1) for the first averaging filter and a different second threshold value (e.g., threshold2) for the second averaging filter. Preferably two different sets of data are generated, such as p1(i) and p2(i). As a general matter, for data that is not calculated, any other available set of data may be used. In addition, it is to be understood that more than 3 neighbor pixels may be used with any of the techniques.

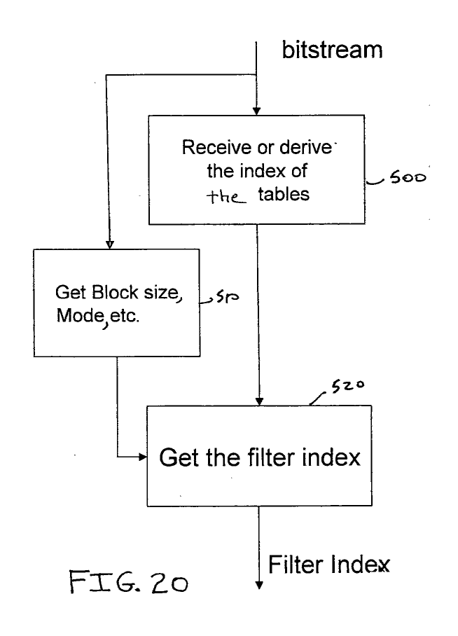

Referring to FIG. 20, in some cases it may be desirable to select between multiple different index tables (see FIG. 17), to further improve image encoding and decoding. The decoder may have one or more predefined index tables, one or more index tables received in the bit stream, one or more index tables determined based upon the image content, or otherwise. Each of the tables may be different from one another, or otherwise a portion of the index table may be modified, effectively providing a different index table. The decoder receives a table index from the bit stream or otherwise derives the index for the desired the table 500. In some cases, the index for the desired table may indicate that no table should be used (all filter index in the table is 0) and thus a default technique should be used. In some cases, the index for the desired table may indicate that no filter should be used for 4×4 block. The decoder also receives additional information related to block size, mode, etc. 510. This additional information 510 may be used in combination with the index 500 to select the appropriate filter index 520 from within the selected table. The filter index 530 is then used in the decoder to get the neighbor pixels for intra prediction. In some cases, the bit stream may indicate that selected block sizes should not use the table, and thus a default technique should be used. In some cases, the bit stream may indicate an offset value for the filter index, such that additional tables do not necessarily need to be provided to the decoder. For example, an offset of 1 may indicate that the filter index 0 should use filter index 0, filter index 1 should use filter index 0, and that filter index 2 should use mode 1.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A decoder for decoding video comprising:
(a) said decoder decoding a block of video frame received in a bit stream based upon other blocks of said video frame without using blocks of other frames;
(b) said decoding based upon a directional prediction index received in said bit stream using a technique that is dependent on the size of said block;
(c) wherein said index selectively indicates one of (1) a first technique based on non-filtered received pixel values; (2) a second technique based upon a first smoothing filter; and (3) a third technique based upon a second smoothing filter;
(d) wherein said first smoothing filter and said second smoothing filter are based upon an edge determination.

2. The decoder of claim 1 wherein said first smoothing filter is based upon three pixels.

3. The decoder of claim 2 wherein said three pixels include a center pixel, a pixel to the left, and a pixel to the right.

4. The decoder of claim 3 wherein said first smoothing filter substantially averages said three pixels.

5. The decoder of claim 1 wherein said second smoothing filter is based upon three pixels.

6. The decoder of claim 5 wherein said three pixels include a center pixel, a pixel to the left, and a pixel to the right.

7. The decoder of claim 6 wherein said second smoothing filter substantially averages said three pixels.

8. The decoder of claim 7 wherein said center pixel is based upon the results of said first smoothing filter.

9. The decoder of claim 1 wherein said edge determination is based upon a threshold value.

10. The decoder of claim 9 wherein said threshold value is received in said bit stream.

11. The decoder of claim 1 wherein said first smoothing filter has a first threshold for said edge determination, and said second smoothing filter has a second threshold for said edge determination.

12. The decoder of claim 11 wherein said first threshold and said second threshold are different.

13. The decoder of claim 11 wherein said first threshold is provided in said bit stream.

14. The decoder of claim 11 wherein said threshold is dependent on the size of said block.

15. The decoder of claim 11 wherein said threshold is dependent on the content of said frame.

16. The decoder of claim 11 wherein said threshold is dependent on the image resolution of said frame.

17. The decoder of claim 11 wherein said threshold is dependent on the Quantization parameter of at least one of said frame and said block.

18. The decoder of claim 11 wherein said first threshold and said second threshold are the same.

19. The decoder of claim 1 wherein said decoder selects among a plurality of different sets of directional prediction indexes.

20. The decoder of claim 20 wherein one of said plurality of direction prediction indexes is a default set.

21. The decoder of claim 20 wherein said plurality of direction prediction indexes are received in said bit stream.

22. The decoder of claim 20 wherein said plurality of direction prediction indexes are derived from data in said bit stream.

23. The decoder of claim 20 wherein at least one of said modes of said plurality of direction prediction indexes are indicated as not used.

24. The decoder of claim 20 further including an offset related to said prediction indexes.
